(19) United States
(12) Patent Application Publication
(10) Pub. No.: US 2009/0034276 A1
(43) Pub. Date: Feb. 5, 2009

(54) OPTICAL SCATTERING OF LIGHT BEAM

(75) Inventors: Roland Mueller, Lautertal (DE); Boris Niemann, Rheda-Wiedenbrueck (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/174,801

(22) Filed: Jul. 17, 2008

(30) Foreign Application Priority Data
Aug. 3, 2007 (DE) 10 2007 036 697.5

(51) Int. Cl. B60Q 1/04

(52) U.S. Cl. 362/466

(57) ABSTRACT

A system for controlling the optical scattering of a light beam in a vehicle comprises a light source, a reflector, a lens, and a headlamp controller. The light source is adapted to generate the light beam. The reflector is positioned about the light source to reflect the light beam. The lens is positioned a distance away from the light source and adapted to receive the light beam from the light source and the reflector and to project the light beam from the vehicle. The headlamp controller is operably coupled to a kinematic sensing device that detects motion characteristics of the vehicle and generates a kinematic signals. The headlamp controller is configured to linearly adjust the distance between the light source and the lens in response to the kinematic signals.

### CROSS-REFERENCE TO RELATED APPLICATIONS

This application claims priority to German Application No. 10 2007 036 697.5, filed on Aug. 3, 2007, the disclosure of which is hereby incorporated in its entirety.

### BACKGROUND

1. Technical Field

The embodiments of the present invention described herein generally relates to a system for controlling the optical scattering of a light beam in a vehicle.

2. Background Art

Front lighting systems provide for different lighting schemes based on the state of a vehicle. Such lighting systems include a lens, reflector and a light source positioned within a headlamp housing. The lighting systems scatter the light beam differently to support the different lighting schemes by adjusting the distance between the lens and the light source using fixed points or known distances. In most situations, the adjustment of the distance between the lens and the light source is generally noticeable to the driver since the adjustment of the distance between the lens and the light source is generally accompanied with hard stops due to the fixed points. Further, by adjusting the distance between the light source and the lens with fixed points, such a process may not capture an ideal distance between the lens and the light source based on a given vehicle state since the fixed distances may not take into account all intermediate distances.

Accordingly, it would be desirable to provide a system for controlling the optical scattering of a light beam in a vehicle that is not noticeable to the driver. In addition, it would be desirable to provide a system for controlling the optical scattering of the light beam in the vehicle that provides for a soft or linear transition to take into account all intermediate distances that are possible based on a given vehicle state.

### SUMMARY

In one embodiment, a system for controlling the optical scattering of a light beam in a vehicle comprises a light source, a reflector, a lens, and a headlamp controller. The light source is adapted to generate the light beam. The reflector is positioned about the light source to reflect the light beam. The lens is positioned a distance away from the light source and adapted to receive the light beam from the light source and the reflector and to project the light beam from the vehicle. The headlamp controller is operably coupled to a kinematic sensing device that detects motion characteristics of the vehicle and generates kinematic signals. The headlamp controller is configured to linearly adjust the distance between the light source and the lens in response to the kinematic signals.

In another embodiment, a system for controlling the optical scattering of a light beam in a vehicle comprises a first light source, a second light source, a first reflector, a second reflector, a first lens, a second lens, and a headlamp controller. The first light source is adapted to generate the first light beam. The second light source is adapted to generate the second light beam. The first reflector is positioned about the first light source. The second reflector is positioned about the second light source. The first and second reflectors are adapted to reflect the first and second light beams, respectively. The first lens is positioned at a first distance away from the first light source and is adapted to receive to the first light beam from the first light source and the first reflector and to project the first light beam from the vehicle. The second lens is positioned at a second distance away from the second light source and is adapted to receive the second light beam from the second light source and the second reflector and to project the second light beam from the vehicle. The headlamp controller is operably coupled to a kinematic sensing device that detects motion characteristics of the vehicle and generates a plurality of kinematic signals. The headlamp controller is configured to linearly adjust the first distance and the second distance in response the kinematic signals

In another embodiment, a system for controlling the optical scattering of a light beam in a vehicle comprises a light source, a reflector, a lens, and a headlamp controller. The light source is adapted to generate the light beam. The reflector is positioned at a first distance away from the light source to reflect the light beam. The lens is positioned at a second distance away from the light source to receive the light beam from the reflector and the light source and to project the light beam from the vehicle. The headlamp controller is operably coupled to a kinematic sensing device that detects motion characteristics of the vehicle and transmits a plurality of kinematic signals. The headlamp controller is configured to linearly adjust one of the first distance and the second distance in response to the kinematic signals.

### BRIEF DESCRIPTION OF THE DRAWINGS

FIG. 1 depicts a front lighting system;

FIG. 2 depicts a plain view for a headlamp assembly having a single focal point;

FIG. 3 depicts a side view for the headlamp assembly of FIG. 2;

FIG. 4 depicts a plain view for the headlamp assembly having multiple focal points;

FIG. 5 depicts a side view of the headlamp assembly of FIG. 4; and

FIG. 6 depicts a plain view for the headlamp assembly having multiple focal points and additional reflectors.

### DETAILED DESCRIPTION OF THE PREFERRED EMBODIMENT(S)

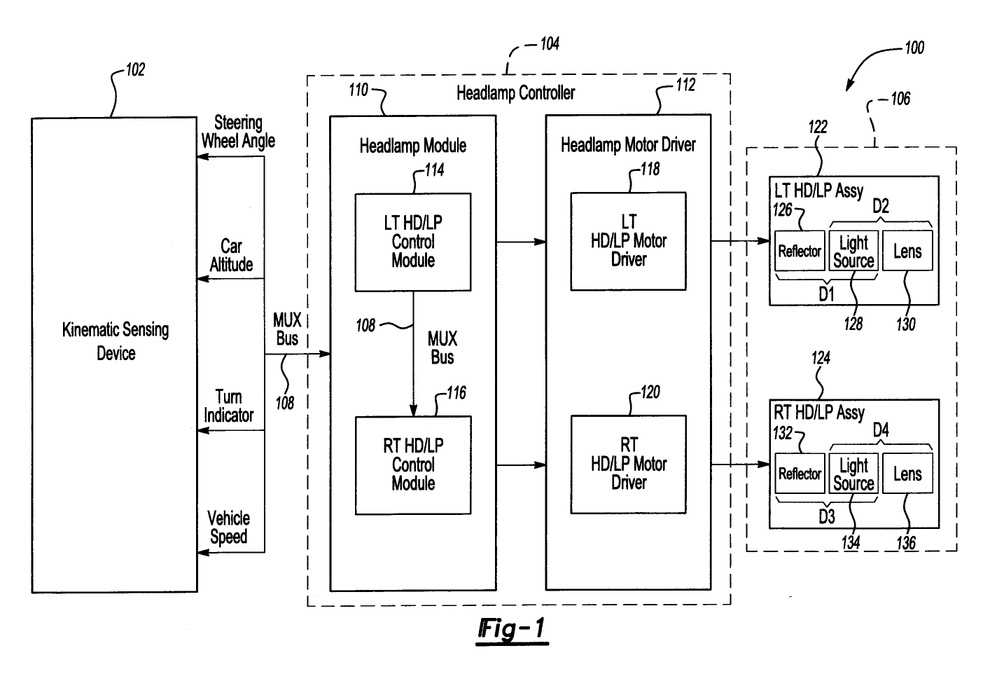

FIG. 1 depicts a front lighting system 100. The lighting system 100 may be adapted for use in a vehicle or any other such apparatus that is operated by a user at night. The lighting system 100 comprises a kinematic sensing device 102, a headlamp controller 104 and a headlamp assembly 106. The kinematic sensing device 102 is adapted to detect motions characteristics of the vehicle and generate a plurality of kinematic signals. The kinematic signals generally correspond to the motion characteristics of the vehicle.

In one example, the kinematic sensing device 106 may include a plurality of controllers (not shown) and sensors (not shown) positioned throughout the vehicle for detecting and transmitting the kinematic signals. The kinematic signals include vehicle speed, a front car altitude, turn indicator signals (left and right), a rear car altitude and a steering wheel angle. The kinematic sensing device 102 may include a powertrain controller (PCM) or a chassis controller and a plurality of wheel speed sensors. The plurality of wheel speed sensors may be positioned about wheels of the vehicle for detecting vehicle speed. The wheel speed sensors may transmit the wheel speed in raw data to the PCM or the chassis controller. The PCM or chassis controller may process the raw data and compute the vehicle speed. The data transmitted by the wheel speed sensors may be based on an 8,000 pulses per mile (8 KPPM) format. The PCM or chassis controller may process the raw data based on the 8 KPPM format and transmit the vehicle speed over a multiplexed (MUX) bus 108 as a vehicle speed message to the headlamp controller 104. In one example, the MUX bus 108 may be implemented either as a high or medium speed controller area network (CAN). In another example, the MUX bus 108 may be implement as a local interconnect network (LIN). The particular type of multiplexed protocol used may vary based on the desired criteria of a particular implementation.

In another example, an interior body electronic module may be disposed about the interior of the vehicle to provide turn indicator signals over the MUX bus 108 to the headlamp controller 104. In another example, a plurality of steering wheel position sensors may be positioned about a steering wheel shaft to detect the steering wheel angle of the steering wheel. The steering wheel position sensors may transmit raw data related to the steering wheel angle to the chassis controller. The chassis controller may process the raw data related to the steering wheel angle and transmit a steering wheel angle message over the MUX bus 108 to the headlamp controller 104. In another example, the kinematic sensing device may include an inertial measuring unit (IMU) and a global positioned system (GPS) unit to detect the front and rear altitude of the car. The IMU and GPS units may transmit the front and rear car altitudes over the MUX bus 108 to the head lamp controller 104 and transmit car altitude messages over the MUX bus 108.

Additional examples, may include the kinematic sensing device 102 providing raw data related to the vehicle speed, the steering wheel angle and the car altitudes directly to the headlamp controller 104 (e.g., without the use of the MUX bus 108). The headlamp controller 104 may include additional hardware and software for processing the raw data associated with the various kinematic signals.

The headlamp controller 104 includes a headlamp module 110 and a headlamp motor driver 112. The headlamp module 110 includes a left headlamp control module 114 and a right headlamp control module 116. The left and right headlamp control modules 114, 116 are adapted to receive the kinematic signals over the MUX bus 108. In one example, the left and right headlamp control modules 114, 116 may be implemented in a master-slave configuration. With such a master-slave configuration, the MUX bus 108 may be coupled between the headlamp control modules 114, 116 to facilitate data communication between the headlamp control modules 114, 116.

The headlamp control modules 114, 116 may each have a dedicated input adapted to receive a particular voltage from another controller located elsewhere in the vehicle to designate which of the headlamp control modules 114, 116 is to serve as the master or slave. During vehicle start up, the input of the left headlamp control module 114 may receive a ground (GND) and the right headlamp control module 116 may receive 5V or 12V. The control modules 114, 116 may be configured such that the module that receives the GND is the master and the module that receives 5V or 12V is the slave. The left headlamp control module 114 (e.g., the master) may transmit messages over the MUX bus 108 to the right headlamp control module 116 (e.g., the slave). The designation with respect to which control module 114, 116 becomes the master or the slave and may vary based on the desired criteria of a particular implementation. The control module 114 or 116 that is configured as the master generally includes a headlamp control algorithm and transmits control signals over the MUX bus 108 to the slave.

In another example with respect to the master-slave implementation, a vehicle controller packaged elsewhere in the vehicle along with the control modules 114, 116 may serve as the headlamp controller 104. In such an example, the vehicle controller may serve as the master and the control modules 114, 116 may serve as slaves. The vehicle controller may include the headlamp control algorithm and transmit control messages over the MUX bus 108 to the control modules 114, 116.

While FIG. 1 depicts that the headlamp controller 104 includes left and right control modules 114, 116, the left and right control modules 114, 116 may be combined into a single controller. In such a configuration, the headlamp controller 104 may include all of the needed software and hardware for controlling the headlamp motor driver 112. The particular implementation with respect to the number of control modules implemented in the system 100 may vary based on packaging and cost constraints.

The system 100 is adapted to perform headlamp leveling curve lighting for the vehicle. The system 100 may simultaneously perform headlamp leveling and curve lighting at the same time. The headlamp motor driver 112 includes a left headlamp motor driver 118 and a right headlamp motor driver 120. The headlamp assembly 106 includes a left headlamp assembly 122 and a right headlamp assembly 124. The left and right headlamp assemblies 122, 124 are adapted to generate left and right light beams, respectively. To perform headlamp leveling, the motor drivers 118, 120 may adjust the vertical position of the left and right light beams projected from the headlamp assemblies 122, 124 in response to control signals generated by the control modules 114, 116. To perform curve lighting, the motor drivers 118, 120 may adjust the angular rotation of the left and right light beams projected from the headlamp assemblies 122, 124 about a horizontal axis in response to control signals generated by the control modules 114, 116.

The left headlamp assembly 122 includes a reflector 126, a light source 128, and a lens 130. The light source 128 may include a plurality of light emitting devices (LEDs), Xenon and light bulbs (e.g., H7 or H9). The light source 128 is adapted to generate the left light beam. The lens 130 may be implemented in a number of colors (e.g., limpid (clear), white or blue). The reflector 126 is adapted to reflect the left light beam. The lens 128 receives the left light beam from the reflector 126 and the light source 128 to project the left light beam from the vehicle. The reflector 126 is generally positioned away from the light source 128 by a distance, D1. The lens 128 is generally positioned away from the light source 128 by a distance, D2.

The right headlamp assembly 124 includes a reflector 132, a light source 134, and a lens 136. The light source 134 may include a plurality of light emitting devices (LEDs), Xenon and light bulbs (e.g., H7 or H9). The light source 134 is adapted to generate the right light beam. The lens 136 may be implemented in a number of colors (e.g., limpid (clear), white or blue). The reflector 132 is adapted to reflect the right light beam. The lens 136 receives the right light beam from the reflector 132 and the light source 134 to project the right light beam from the vehicle. The reflector 132 is generally positioned away from the light source 134 by a distance, D3. The lens 136 is generally positioned away from the light source 134 by a distance, D4.

In operation, the headlamp controller 104 may be adapted to linearly change the distances D1 and D3 between the reflectors 126, 132 and the light sources 128, 134 in response to the kinematic signals. In another embodiment, the headlamp controller 104 may be adapted to linearly change the distances D2 and D4 between the lens 130, 136 and the light sources 128, 134 in response to the kinematic signals. Such a linear transition between the distances D1 and D3 and/or D2 and D4 may provide for a soft transition while optically scattering the light beams as the vehicle undergoes different driving characteristics. For example, different lighting schemes (e.g., different levels of optical scattering of the light beams) may be needed based on the state of the vehicle as the vehicle travels on a road.

In one example, if the vehicle is traveling in a generally straight pattern on the road with a speed up to 30 km/h and the steering wheel angle is zero or close to zero, such a condition may be indicative of the vehicle performing city driving. In such a condition, the headlamp controller 104 may detect that city lighting may need to be provided to the driver in response to the kinematic signals (e.g., vehicle speed and steering wheel angle). With city lighting, the headlamp controller 104 may control the distances D2 and D4 between the left and right lens 130, 136 and the left and right light sources 128, 134 so that the distances D2 and D4 are equal to one another.

With city lighting, the light beams may be configured so that each light beam is generally scattered equally to one another (or homogenous with one another) in order to provide for an equal and broad range of visibility across the immediate lane in which the vehicle is traveling and the lane that on-coming vehicles may drive upon including any area of land adjacent to the both sides of the lanes (e.g., the immediate lane and the lane driven upon by on-coming traffic).

If the vehicle is traveling at a speed between 30 km/h and 80 km/h and the steering wheel angle is zero or close to zero, then the headlamp controller 104 may determine that normal lighting may be needed for the driver. With normal lighting, the headlamp controller 104 may control the distances D2 and D4 between the left and right lens 130, 136 and the left and right light sources 128, 134 so that the distances D2 and D4 between the lens 130, 136 and the light sources 128, 134 are equal to one another. With normal lighting, the left and right light beams may be configured so that each light beam is generally scattered equally to one another (homogenous with one another) to provide for an equal range of visibility across the road.

If the vehicle is traveling at a speed between 80 km/h and 120 km/h and the steering wheel angle is zero or close to zero, then the headlamp controller 104 may determine that overland lighting may be needed for the driver. With overland lighting, the headlamp controller 104 may control the distances D2 and D4 between the left and right lens 130, 136 and the left and right light sources 128, 134 so that the distances D2 and D4 between the lens 130, 136 and the light sources 128, 134 are equal to one another. With overland lighting, the left and right light beams may be configured so that each light beam is generally scattered equally to one another (homogenous with one another) to provide for an equal range of visibility across the road.

If the vehicle is traveling at a higher speed (e.g., greater than 120 km/h) and the steering wheel angle is zero or close to zero, then the controller 104 may determine that motorway (or highway) lighting may be needed for the driver. With motorway lighting, the headlamp controller 104 may control the distances D2 and D4 between the left and right lens 130, 136 and the left and right light sources 128, 134 so that the distances D2 and D4 between the lens 130, 136 and the light sources 128, 134 are equal to one another. With motorway lighting, the left and right light beams may be configured so that each light beam is generally scattered equally to one another (homogenous with one another) to provide for an equal range of visibility across the road.

With motorway lighting, the optical scattering of the left and right light beams may not be as broad as the scattering provided for city lighting, normal lighting and overland lighting. In general, with motorway lighting, the light beams are equally scattered across the current lane that the vehicle is traveling on and on the surface of land adjacent to the current lane.

While the distances D2 and D4 may be similar to each other as noted in connection with city, normal, overland and motorway lighting; the distances D1 and D3 may also be similar to each other if the headlamp controller 104 is configured to adjust the distance between the left and right reflectors 126, 132 and the left and right light sources 128, 134. The system 100 may achieve similar results by linearly changing the distances D1 and D3 or by linearly changing the distances D2 and D4. The headlamp control algorithm is adapted to calculate the linear changes in distances.

For city and motorway lighting, the system 100 may incorporate headlamp leveling. For example, the headlamp controller 104 (via the control modules 114, 116 and the motor drivers 118, 120) may vertically adjust the left and right headlamp assemblies 122, 124 based on the car altitude. In one example, if the vehicle is traveling with a large amount of mass or weight in rear of the vehicle, the rear altitude of the vehicle may be lower than the front altitude of the vehicle. With city, normal, overland or motorway lighting and such an example involving the rear altitude of the vehicle, the headlamp controller 104 may adjust the headlamp assembly so that the distances D1 and D3 (or D2 and D4) are similar to each and further adjust the headlamp assemblies 106 and 124 to project the light beams at a lower position to compensate for the additional amount of weight placed in the vehicle.

As noted with curve lighting above, the headlamp controller 104 may rotate the headlamp assemblies 122 and 124 in an angular direction about the horizontal axis if the vehicle is driving on a curved path. In general, with curve lighting, the headlamp controller 104 may adjust the distances D2 and D4 to be different from one another (or the distances D1 and D3 to be different from one another). For example, if the vehicle is driving in a curve, the light beam that is located on the inside track of the curve may be more scattered (to provide for greater visibility over the inside track for the driver) than the light beam that is located on the outside track of the curve. The headlamp controller 104 may perform headlamp leveling, curve lighting and linearly change the distance D2 and D4 (or D1 and D3) at the same time.

In addition to curved lighting, the system 100 may also perform cornering lighting. Cornering lighting generally refers to a lighting scheme produced by the system 100 when the vehicle, just prior to coming to a complete stop, begins to make a left or right turn. The controller 104 may determine that cornering light is needed based on the vehicle speed, the steering wheel angle and the turn indicator. If the headlamp controller 104 detects that the vehicle speed steering wheel angle and turn indicator thresholds are met to establish that the vehicle is in a cornering state, the headlamp controller 104 may adjust the distances D1 and D3 to be different from one another (or adjust the distances D2 and D4 to be different from one another). The light beam projected over the inside track of the turn may be more scattered than the light beam projected over the outside track. For example, if the vehicle is making a right turn, the light beam projected from the right headlamp assembly 124 may be more scattered than the light beam emitted from the left headlamp assembly 122.

In general, by linearly increasing or decreasing the distances D1 and D3 (or D2 and D4), the system 100 scatters the light beam in such a manner that is transparent to the driver when different lighting schemes are provided by the system 100 based on the state of the vehicle. By linearly increasing or decreasing the distances D1 and D3 (or D2 and D4), the system 100 takes into account all distances that are possible based on the different vehicle states.

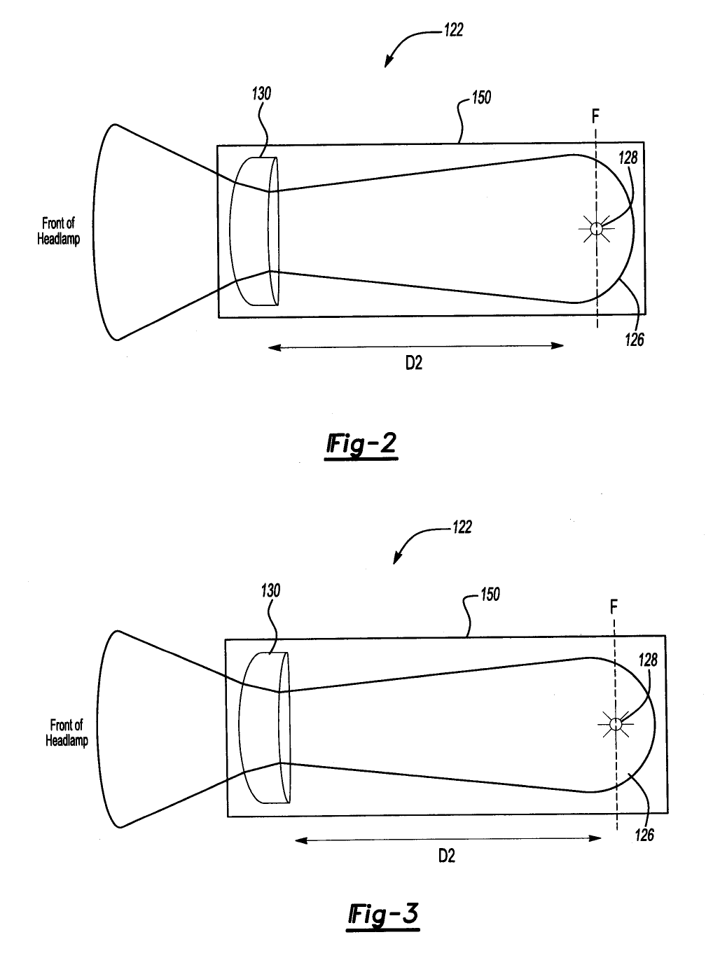

FIG. 2 depicts a plain view for the headlamp assembly 122 having a single focal point. All references made to the left headlamp assembly 122 as noted in connection with FIG. 2 may also apply to the right headlamp assembly 124 and the corresponding elements illustrated therein. The plain view as depicted in FIG. 2 generally refers only to a view of the light beam as seen from above the vehicle as the light beam is being projected from the assembly 122.

The left headlamp assembly 122 generally includes the reflector 126, the light source 128, the lens 130 and a housing 150. A single focal point F is shown directly at the light source 128. The presence of the single focal point F is generally based on the design of the reflector 126. The reflector 126 is spherical in shape thereby producing the focal point F with the light beam. The reflector 126 and the light source 128 are mounted together in the housing 150. The distance D1 between the reflector 126 and the light source 128 may be linearly increased and decreased by the headlamp controller 104 in response to the kinematic signals. In addition, the distance D2 between the light source 128 and the lens 130 may be linearly increased or decreased by the headlamp controller 104 in response to the kinematic signals. The scattering (or focusing) is generally defined by the amount of the light beam that falls on the lens 130 (or the incident light). If the width of the incident light is greater, then the scattering of the light beam is greater. If the width of the incident light is smaller, then the scattering of the light beam is less which generally results in a more focused light beam. By controlling the distance D2 and D4 between the light source 128 and the lens 130, the system 100 controls the amount of light in the light beam that falls on the lens 130.

FIG. 3 depicts a side view of the headlamp assembly 122 having the single focal point as depicted in FIG. 2. The side view as depicted in FIG. 3 generally refers to a view of the light beam as seen from a lateral side of the vehicle as the light beam is projected out of the assembly 122.

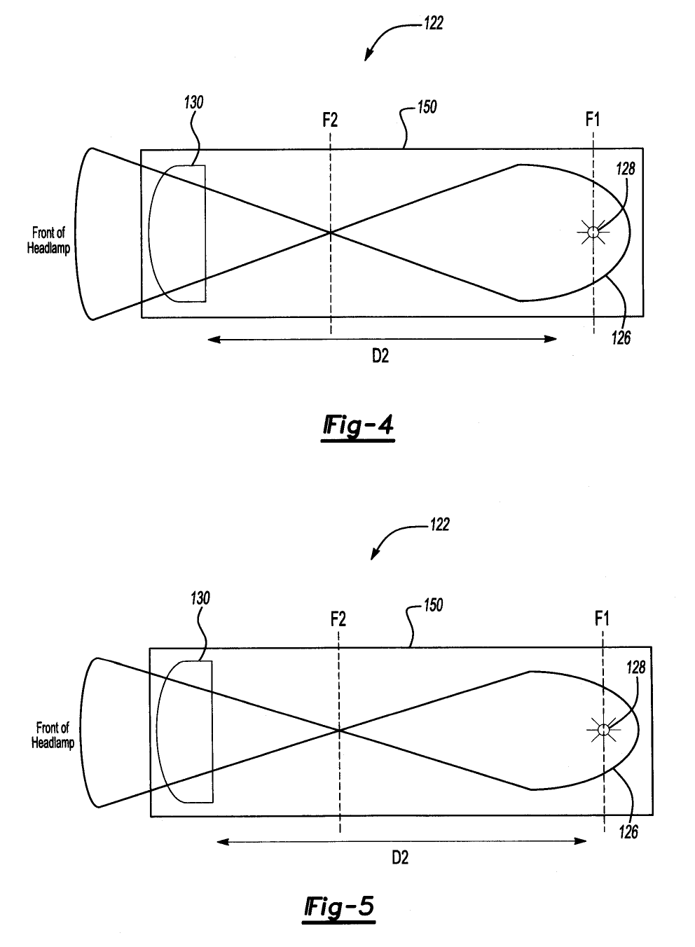

FIG. 4 depicts a plain view for the headlamp assembly 122 having multiple focal points. All references made to the left headlamp assembly 122 as noted in connection with FIG. 4 may also apply to the right headlamp assembly 124 and the corresponding elements illustrated therein. The plain view as depicted in FIG. 4 generally refers only to a view of the light beam as seen from above the vehicle as the light beam is being projected from the assembly 122.

A first focal point F1 is shown directly at the light source 128. A second focal point F2 is shown between the lens 130 and the light source 128. The length of the housing 150 as depicted in FIG. 4 may be greater than the length of the housing 150 as depicted in FIGS. 2-3. The focus points of the light beam are based on the design of the reflectors. For example, the reflector 126 is parabolic in shape thereby generating the focal points F1 and F2 with the light beam. Similar characteristics as noted in connection with FIG. 2 with respect to the scattering of the light beam may be exhibited as the headlamp controller 104 linearly increases or decreases the distances D1 or D2 in response to the kinematic signals. However, a difference between the headlamp assembly 122 with multiple focal points and the headlamp assembly 122 with a single focal point is that the multiple focal point configuration provides for a greater scattering effect. A greater angle of incident light may be presented to the lens 130 thereby increasing the scattering effect of the light beam.

FIG. 5 depicts a side view of the headlamp assembly 122 having multiple focal points as depicted in FIG. 4. The side view as depicted in FIG. 5 generally refers to a view of the light beam as seen from the lateral side of the vehicle as the light beam is being projected from the assembly 122.

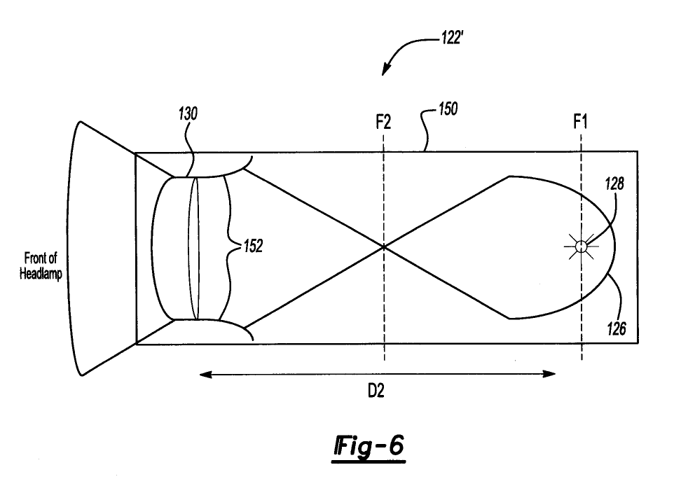

FIG. 6 depicts a plain view for a headlamp assembly 122′ having multiple focal points. All references made to the left headlamp assembly 122′ as noted in connection with FIG. 6 may also apply to the right headlamp assembly 124 and the corresponding elements illustrated therein. The plain view as depicted in FIG. 4 generally refers only to a view of the light beam as seen from above the vehicle as the light beam is being projected from out of the headlamp assembly 122′.

The headlamp assembly 122′ includes the reflector 126, the light source 128, the lens 130 and a pair of reflectors 152. In another implementation, a reflector may also be positioned on an inner car side of the housing 150. The pair of reflectors 152 are coupled to the lens 130. The first focal point F1 is shown directly at the light source 128. The second focal point F2 is shown between the light source 128 and the lens 130. The length of the housing 150 may be greater than the length of the housing 150 as depicted in FIG. 2. The focus points of the light beam are based on the design of the reflectors. Similar characteristics as noted in connection with FIGS. 2-5 with respect to the scattering of the light beam may be exhibited as the headlamp controller 104 linearly increases or decreases the distances D1 or D2 in response to the kinematic signals.

The addition of the pair of reflectors 152 to the lens 130 further increases the incident angle of the light beam into the lens 130 over the assembly 122 as described in connection with FIGS. 4-5. By providing a light beam that includes a large enough width so that portions of the light beam reflect off of the pair of reflectors 152, an additional reflection may be exhibited which may lead to an increase in the angle of incident light into the lens 130 thereby increasing the scattering effect of the light beam. By changing the distance D2 between the light source 128 and the lens 130, the system 100 may control the amount of light that is reflected off of the reflectors 152 and the placement of the lens 130 with respect to the angle of incident light. The right headlamp assembly 124 may also be adapted to include a pair of reflectors 152 coupled to the lens 136 in order to increase the scattering effect of the light beam.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for controlling the optical scattering of a light beam in a vehicle, the system comprising:
a light source adapted to generate the light beam;
a reflector positioned about the light source to reflect the light beam;
a lens positioned a distance away from the light source and adapted to receive the light beam from the light source and the reflector and to project the light beam from the vehicle; and
a headlamp controller operably coupled to a kinematic sensing device that detects motion characteristics of the vehicle and generates a plurality of kinematic signals, the headlamp controller is configured to linearly adjust the distance between the light source and the lens in response to the kinematic signals.

2. The system of claim 1 wherein the headlamp controller is configured to linearly adjust the distance between the light source and the lens in response to the kinematic signals while the system levels the light beam.

3. The system of claim 1 wherein the headlamp controller is configured to linearly adjust the distance between the light source and the lens in response to the kinematic signals while the system provides curve lighting for the vehicle.

4. The system of claim 1 wherein the light source is one of a plurality of light emitting devices and Xenon.

5. A system for controlling the optical scattering of first and second light beams in a vehicle, the system comprising:
a first light source adapted to generate the first light beam;
a second light source adapted to generate the second light beam;
a first reflector positioned about the first light source;
a second reflector positioned about the second light source, the first and second reflectors being adapted to reflect the first and second light beams respectively;
a first lens positioned at a first distance away from the first light source and adapted to receive to the first light beam from the first light source and the first reflector and to project the first light beam from the vehicle;
a second lens positioned at a second distance away from the second light source and adapted to receive the second light beam from the second light source and the second reflector and to project the second light beam from the vehicle; and
a headlamp controller operably coupled to a kinematic sensing device that detects motion characteristics of the vehicle and generates a plurality of kinematic signals, the headlamp controller is configured to linearly adjust the first distance and the second distance in response the kinematic signals.

6. The system of claim 5 wherein the first distance is equal to the second distance when the vehicle is in a first state.

7. The system of claim 6 wherein the first state of the vehicle is defined as the vehicle driving on a straight road.

8. The system of claim 5 wherein the first distance is not equal to the second distance when the vehicle is in a second state.

9. The system of claim 8 wherein the second state of the vehicle is defined as one or more of the vehicle driving on a curved road and the vehicle performing a turn.

10. The system of claim 5 wherein the light source is one of a plurality of light emitting devices and Xenon.

11. The system of claim 5 wherein the headlamp controller is configured to linearly adjust the first distance between the first light source and the first lens and the second distance between the second light source and the second lens in response to the kinematic signals while the system levels the first and second light beams.

12. A system for controlling the optical scattering of a light beam in a vehicle, the system comprising:
a light source adapted to generate the light beam;
a reflector positioned at a first distance away from the light source to reflect the light beam;
a lens positioned at a second distance away from the light source to receive the light beam from the reflector and the light source and to project the light beam from the vehicle; and
a headlamp controller operably coupled to a kinematic sensing device that detects motion characteristics of the vehicle and transmits a plurality of kinematic signals, the headlamp controller is configured to linearly adjust one of the first distance and the second distance in response to the kinematic signals.

13. The system of claim 12 wherein the headlamp controller is configured to linearly adjust the first distance and the second distance in response to the kinematic signals while the system levels the light beam.

14. The system of claim 12 wherein the headlamp controller is configured to linearly adjust the first distance and the second distance in response to the kinematic signals while the system provides curve lighting for the vehicle.

15. The system of claim 12 wherein the light source is one of a plurality of light emitting devices and Xenon.
